(19) United States
(12) Patent Application Publication
(10) Pub. No.: US 2020/0108552 A1
(43) Pub. Date: Apr. 9, 2020

(54) METHOD FOR THE LAYERWISE CONSTRUCTION OF MOLDED BODIES WITH A NOVOLAC-POLYURETHANE-BASED BINDER SYSTEM

(71) Applicant: ASK Chemicals GmbH, Hilden (DE)

(72) Inventors: Dennis BARTELS, Dorsten (DE); Antoni GIENIEC, Hilden (DE); Natascha HURKES, Mönchengladbach (DE); Arkadius KAMINSKI, Mettmann (US)

(21) Appl. No.: 16/328,374

(22) PCT Filed: Aug. 25, 2017
(86) PCT No.: PCT/DE2017/100719

§ 371 Date: Feb. 26, 2019

(30) Foreign Application Priority Data
Aug. 26, 2016 (DE) 10 2016 115 947.6

(51) Int. Cl. B29C 64/165; B22C 1/22; B29C 64/209; B29K 61/00; C08G 18/76; C08G 18/08; C08G 18/54; B29K 75/00; B33Y 30/00; B33Y 10/00

(52) U.S. Cl. CPC B29C 64/165; B22C 1/2273; B29C 64/209; B29K 2061/00; C08G 18/7621; B33Y 10/00; C08G 18/542; B29K 2075/00; B33Y 30/00; C08G 18/7642; C08G 18/0852

(57) ABSTRACT

The invention relates to a method for the layerwise construction of bodies comprising at least one novolac in a solid, free-flowing form; an isocyanate component and a first solvent as a liquid component to be printed, wherein the solvent according to a preferred embodiment of the invention also has a catalyst dissolved in the first solvent; a corresponding construction material mixture; a component system for producing the bodies by means of 3-D printing; and three-dimensional bodies produced according to this method in the form of molds and cores for metal casting.

The invention relates to a method for the layerwise construction of bodies comprising at least one novolac in a solid, free-flowing form; an isocyanate component and a first solvent as a liquid component to be printed, wherein the first solvent according to a preferred embodiment of the invention also has a catalyst dissolved in the first solvent; a corresponding construction material mixture; a component system for producing the bodies by means of 3-D printing; and three-dimensional bodies produced according to this method in the form of molds and cores for metal casting.

Various methods are known for the layerwise construction of three-dimensional molded bodies under the designation of “rapid prototyping” or “3-D printing”. With the assistance of this method, bodies with even the most complicated geometries can be produced directly from the CAD data without molding tools. This is not possible with conventional methods.

According to EP 0882568 B1, to produce the 3-D body, a loose mold base material, preferably in the form of a Croning sand, is first selectively provided with a so-called modifier in layers by printing. These modifiers are for example an alcohol or an acid that have the task in the subsequent solidification step of either inhibiting or accelerating thermal hardening. When using a reaction inhibitor, the mold base material/binder mixture hardens while forming the desired molded part while heating at the locations that were not treated with the modifier. When using a reaction accelerator, the binder and the latent hardener contrastingly react with each other at the locations provided with the modifier and bind the particles that were loose up to that time into the finished unit. This can then be freed from the loose, non-hardened molding material/binding mixture as usual. Normally, about 10-15% hexamethylene tetramine relative to the amount of sand is added as a part of the construction material mixture to the Croning sands encased in novolac that are described in EP 0882568 B1. This is split into ammonia and formaldehyde under the effect of heat while processing and therefore initiates the hardening process. An isocyanate component is not part of the composition.

EP 1324842 B1 discloses a method in which a binder is applied selectively in layers to the loose mold base material from which the three-dimensional body is to be constructed. Analogous to the approach of an inkjet printer, the binder is applied in this context by means of a thin jet, or a bundle of thin jets. The hardening only occurs when all of the layers required to produce the three-dimensional body are finished. The hardening reaction is for example triggered by flooding the entire unit with a hardener, preferably a gas.

In WO 01/68336 A2, the binder such as a furane resin, a phenol resin or a resol ester is not applied selectively in layers but rather sprayed over the entire working surface of the loose molding material and then also hardened in layers by selectively applying a hardener such as an organic acid. EP 1268165 B1 varies this method by applying both liquid binder and liquid hardener selectively one after the other and in layers to the sections to be hardened.

This method was developed in EP 1509382 B1. The binder is not printed in layers but rather mixed directly with the mold base material. This molding material/binder mixture is then hardened by selectively applying the hardener.

In EP 1638758 B1, the sequence of addition is reversed. First, the molding material is premixed with an activator (hardener), and then the binder is selectively applied in layers. Hardeners that are mentioned are inter alia acids such as aqueous p-toluene sulfonic acid, and binders that are mentioned are phenol resins, polyisocyanates, polyurethanes, epoxide resins, furane resins, polyurethane polymers, phenol polyurethanes, phenol formaldehyde furfuryl alcohols, urea formaldehyde furfuryl alcohols, formaldehyde furfuryl alcohols, peroxides, polyphenol resins, resol esters, silicates (such as sodium silicate), salt, gypsum, bentonite, water-soluble polymers, organic acids, carbohydrates or proteins.

A method is described in DE 102014106178 A1 in which a molding material is hardened in layers by means of an alkaline phenol resin, an ester, and optionally an inorganic additive.

In DE 102012020000 A1 (US 20150273572 A1), a method is described in which a construction material mixture is applied in layers in the form of a Croning sand and hardened by means of a solvent applied selectively by a print head. A plurality of binders is disclosed, inter alia novolacs. However, it is not disclosed to dissolve, or respectively solubilize a novolac by means of a solvent and then cause it to react with an isocyanate introduced into the construction material. Thermoplastics are also mentioned as hot melt adhesives. However, the present invention relates exclusively to binders that form thermosetting plastics.

In particular, the system of acid/furane resin corresponding to EP 1638758 B1 and the system of ester/alkaline phenol resin corresponding to DE 102014106178 A1 have been widely accepted in practice and are used in the development of new cast parts and in the production of individual parts or small series when conventional production with molding tools would be too complicated and expensive, or respectively only conceivable with a complicated core package.

Despite the many advantages of the binder systems already implemented in rapid prototyping such as the speed of production, high dimensional stability and good storage stability of the molds, etc., there is still a need for improvements. Disadvantages of the existing binder systems from DE 102014106178 A1 and EP 1638758 B1 are especially the need for components with a stable viscosity while printing, and the sometimes large amount of water in the molding material mixture that either results from the binder, and the acid and/or the hardening process (condensation reaction). When printing binder systems with an unstable viscosity, the print head can dry and clog. This is associated with sometimes long downtimes and/or high costs for cleaning or replacing the print head. Large amounts of water can disadvantageously affect the full hardening of the molded body and subsequent behavior (such as gas formation) during the casting process.

An equivalent of the cold box method in which a polyol such as in the form of a phenol resin is hardened with isocyanates by being gassed with volatile tertiary amine catalysts is not yet known for rapid prototyping. This is primarily due to the poor printability of the individual components.

The sometimes high viscosity of the polyol, the high technical complexity of gas-hardening systems and the reaction of the isocyanate with humidity during spraying that can cause the print head to clog are disadvantageous. Due to the limited printability of polyol and isocyanate components, a corresponding no-bake or more exactly PEP SET method has not been practically useful to date in which a liquid catalyst is used instead of a gaseous one.

### OBJECT OF THE INVENTION

The object of the present invention is to provide a construction material, or respectively molding material/binder/hardener system that enables the production of 3-D bodies and in particular molds and cores according to the rapid prototyping method, does not have the described disadvantages, and is moreover characterized by the following features:
a) stable over very long periods for the raw materials to be used for the printing process,
b) a low water content in the construction material mixture,
c) minimum equipment requirements,
d) low pollutant emissions, in particular compared with a method based on Croning sands,
e) in terms of chemistry and casting technique, comparable with molds and cores that were produced according to the no-bake (PEP SET) method based on polyurethane binders.

### SUMMARY OF THE INVENTION

These and other tasks are achieved by the subject of the independent claims; advantageous developments are the subject of the dependent claims or are described below.

The method for the layerwise construction of bodies comprises at least the following steps:
a) provide a construction material mixture comprising at least:
   one novolac as a solid,
   and an isocyanate component comprising a polyisocyanate;
b) spread a layer of the construction material mixture with a layer thickness of 0.05 mm to 3 mm, preferably 0.1 mm to 2 mm and particularly preferably 0.1 mm to 1 mm (possibly also in several steps);
c) print selected regions of the layer with a first solvent, wherein the first solvent is in particular free of an isocyanate compound and independent therefrom, is also free of a polyol compound (such as a novolac); and
d) multiple repetition of steps b) and c).

The first solvent is selected so that the first solvent at least partially dissolves the novolac in step c) in order to enable the reaction of the novolac with the polyisocyanate, in particular the layerwise reaction.

Without wishing to be restricted to theory, it is assumed that the novolac is dissolved such that i) solvent first infiltrates into the layers of the novolac particle close to the surface, ii) these layers swell/expand, iii) and become gelatinous before the iv) polymer molecules finally become dissolved. It is assumed that the polyisocyanate reacts with the novolac as of iii).

Preferably, the novolac dissolves in the first solvent at more than 3% by weight, preferably more than 10% by weight, particularly preferably more than 30% by weight, and especially preferably more than 50% by weight relative to the weight of dissolved novolac to be used as a free-flowing, particulate solid.

The solubility of the novolac at the desired temperature, i.e., the working temperature of method step c), is set so that 1000 g of first solvent and 20 g of novolac as a free-flowing, particulate solid are combined at the desired temperature, stirred for two hours at a constant temperature, and the liquid and solid are separated. The solid and liquid can for example be separated by sedimentation and/or filtration. The percent weight of the dissolved novolac relative to the overall novolac used is then the solubility of the novolac.

The method can moreover comprise the following steps:
i) after termination of layerwise construction, harden the body in an oven or by microwaving, and then
ii) remove the unbound construction material mixture from the at least partially hardened mold.

Printing is done with a print head having a plurality of nozzles, wherein the nozzles are preferably selectively controllable individually, wherein the print head is in particular a drop-on-demand print head with a bubble jet or piezo system. The print head is moved by a computer in a controlled manner at least in a plane in order to apply the first solvent in layers.

The component system for producing a construction material mixture comprises at least the following components separately from each other:
Component (A) a novolac in the form of a free-flowing, particulate solid,
Component (B) an isocyanate component comprising a second solvent and at least one polyisocyanate with at least two isocyanate groups dissolved in the second solvent;
Component (C) a first solvent, wherein the tertiary amine is soluble and at least partially dissolves the powdered novolac,

wherein the first solvent is different from the second solvent, and the listed contents of the components are only contained in one of the components.

Moreover, a free-flowing construction material mixture is part of the invention and comprises:
a novolac in the form of a free-flowing, particulate solid,
an isocyanate component comprising at least one polyisocyanate with at least two isocyanate groups, and
a particulate mold base material, preferably a refractory mold base material,

wherein supported novolac such as a Croning sand and the particulate mold base material can form a component.

### DETAILED DESCRIPTION OF THE INVENTION

(1) Construction Material Mixture, or Respectively Molding Material

The construction material mixture comprises all the material that is supplied in layers and is not selectively supplied by the print head, and necessarily novolac and the isocyanate component, preferably also the mold base material. If the mold base material is a refractory mold base material, the term molding material is also used instead of the term construction material mixture. The first solvent and, to the extent that the first solvent contains a catalyst, the catalyst are not part of the construction material mixture or the molding material.

(2) Mold Base Material

All particulate solids can be used as mold base materials that do not dissolve in the presence of the employed solvent(s). The mold base material has a free-flowing state.

Routine and familiar materials can be used as the refractory mold base material for producing the molds. For example, quartz sand, zirconium sand or chrome ore sand, olivine, vermiculite, bauxite, fireclay and mold base materials that are artificially produced, or respectively are obtainable from synthetic materials (such as hollow microspheres) are suitable. Materials are understood to be a refractory mold base material that have a high melting point (melting temperature). Preferably, the melting point of the refractory mold base material is greater than 600° C., preferably greater than 900° C., particularly preferably greater than 1200° C., and especially preferably greater than 1500° C.

The mold base material preferably comprises more than 80% by weight, in particular more than 90% by weight, particularly preferably more than 95% by weight of the molding material, or respectively construction material mixture.

The average diameter of the mold base materials, in particular the refractory mold base materials, is generally between 30 μm and 700 μm, preferably between 40 μm and 550 μm, and particularly preferably between 50 μm and 500 μm. The particle size can be determined for example by sifting according to DIN ISO 3310.

(3) Binder

The binder is a polyurethane obtainable by reacting at least one polyol component and an isocyanate component.

(4) Novolac

The polyol component is a novolac that is present as a solid in a free-flowing, particulate form. Novolacs are meltable, methylene-bridged chain polymers that are stable when stored and are obtained by the polycondensation of an aldehyde with an excess of a phenol compound in the presence of catalytic amounts of an acid or a metal salt (catalyst for producing the novolacs). The aldehyde-to-phenol molar ratio is less than one.

In general, the ratio of aldehyde to the phenol compound in novolacs is not less than 0.3:1 to less than 1:1, preferably 0.4:1 to 0.9:1 and particularly preferably 0.6:1 to 0.9:1.

Suitable phenol compounds are characterized by one or more aromatic rings and a hydroxy substitution on these rings. In addition to phenol itself, examples are substituted phenols such as cresols or nonylphenol, 1,2-dihydroxybenzene (catechol), 1,3-dihydroxybenzene (resorcinol), cashew nut shell oil, i.e., a mixture consisting of cardanol and cardol, or 1,4-dihydroxybenzene (hydroquinone) or phenolic compounds such as bisphenol A or mixtures thereof. Phenol as a phenolic component is particularly preferable.

Suitable aldehydes are for example formaldehyde e.g. in the form of aqueous solutions, or polymers in the form of paraformaldehyde, butyraldehyde, glyoxal and mixtures thereof. Formaldehyde or mixtures containing primarily formaldehyde (relative to the molar amount of the aldehydes) is particularly preferable.

Strong mineral acids such as sulfuric acid, hydrochloric acid or phosphoric acid, organic acids such as sulfonic acids, oxalic acid or salicylic acid or anhydrides such as for example maleic acid anhydride are used as catalysts for the production of the novolacs.

On the other hand, metal salts such as Zn(II), Mg(II), Cd(II), Pb(II), Cu(II) or Ni(II) salts are suitable as the catalysts. Acetates are preferable, and zinc acetate is particularly preferable.

According to the present invention, the novolacs are used in solid and free-flowing form at room temperature (25° C.) since they can be homogeneously incorporated in the construction material mixture.

The average diameter of the novolac particles is preferably between 0.1 μm and 700 μm, preferably between 0.5 μm and 550 μm, and particularly preferably between 1 μm and 300 μm. The average particle diameter can for example be determined by laser diffraction in water using a Horiba LA-960 laser light scattering spectrometer by Retsch based on static laser light scattering (according to DIN/ISO 13320) and using the Fraunhofer model.

The particle shape of the novolac particles can basically be any shape such as fibrous, splintered, sharp-edged, flaky, rounded edge or round as well. However, rounded-edge and rounded particle shapes are preferable. Particularly preferably, spheroid particle shapes are used, wherein these can be ellipsoidal or spherical; spherical are preferred in this case. The ratio of the greatest linear extension to the smallest linear extension of the respective particle shapes (for all directions in space) is preferably less than 10:1, particularly preferably less than 5:1 and especially preferably less than 3:1. Since spherical particle shapes are particularly advantageous, a ratio of the greatest linear extension to the smallest linear extension of 1.1:1 to 1:1 is ideal.

According to one preferred embodiment, the average diameter of the novolac particles is less than or equal to the average diameter of the employed mold base material.

Moreover, it is possible to encase the mold base material with the novolac and use the novolac in a supported form. This is done for example by heating a mixture of novolac and the mold base material above the melting point of the novolac.

This melts the novolac, and the mold base material is encased with novolac. This mold base material provided with novolac (supported novolac) can be used by itself as well as in combination with a loose mixture of mold base material and particulate novolac.

It is also possible to use the mold base materials supported with novolac in the form of a Croning sand in which the catalyst is present in the form of hexamethylene tetramine in a reduced amount, in contrast to the normal added amounts, of more than 0% by weight to about 10% by weight, preferably about 0.05% by weight to about 8% by weight, particularly preferably of about 0.1% by weight to about 5% by weight, and especially preferably of about 0.15% by weight to about 3% by weight relative to the novolac.

Preferably, the mold base material is at least partially encased with the novolac in the absence of hexamethylene tetramine.

Novolacs that are preferably used are characterized by a flow length of 8-130 mm (DIN 8619, addition of 10% hexamethylene tetramine) preferably by a flow length of 10-80 mm, and particularly preferably by a flow length of 15-50 mm. The reactivity of the novolacs is characterized by the flow length (also with reference to the polyurethane reaction). Short flow lengths characterize a high reactivity and hence fast hardening within the disclosed method. The reaction with hexamethylene tetramine is a relative measure of the reactivity with regard to the reaction with the isocyanate groups of the polyisocyanates.

Likewise, the novolacs preferably have a melting point of 40 to 150° C., preferably of 50 to 140° C., particularly preferably of 55 to 130° C., and especially preferably of 60 to 120° C.

Normally, to produce the molds, the novolacs are used at a concentration of 0.3 to 20% by weight, preferably 0.4 to 10% by weight, and particularly preferably of 0.5 to 5% by weight relative to the mold base material in each case.

If there is no mold base material, the novolacs are used at a concentration of 10 to 90% by weight, preferably 20 to 80% by weight, and particularly preferably of 30 to 70% by weight relative to the construction material mixture.

(5) First Solvent

Those solvents are used as the first solvent that entirely or partially dissolve the novolac and accordingly enable selective hardening after layerwise application. The novolac can be dissolved, or respectively solubilized at room temperature or at elevated temperatures, for example at normal working temperatures for step c) of 10 to 40° C., in particular 20 to 30° C. Suitable solvents are organic solvents comprising 1 to 25 carbon atoms and bound oxygen in the form of an alcohol, keto, aldehyde or ester group, and mixtures thereof, in particular aprotic organic solvents having keto, aldehyde, and/or ester groups. Aprotic organic solvents are preferred. Protic solvents such as alcohols react with the polyisocyanate while forming a urethane bond and accordingly are in competition with the novolac, the actual polyol component, so that its use is generally not advantageous. These can however be added to the aprotic solvents and can then serve as a solubilizer and/or crosslinker for multifunctional alcohols.

Examples of suitable first solvents are acyclic or cyclic ketones such as acetone, cyclohexanone or isophorone, or acyclic or cyclic esters such as triacetin, diacetin or monoacetin, dicarboxylic acid esters such as dimethyl esters of dicarboxylic acids like dimethyl glutarate, dimethyl succinate and dimethyl adipate or mixtures thereof such as so-called dibasic esters, carbonic acid esters like dimethyl, propylene or ethylene carbonate, lactones like alpha, beta, gamma or delta lactones like gamma-butyrolactone, glycol ether esters like propylene glycol methyl ether acetate or butyl glycol acetate as well as glycol diesters like propylene glycol diacetate, triethylene glycol diacetate or ethylene glycol diacetate.

Surprisingly it was found that silicic acid esters like tetramethyl, tetraethyl or tetrapropyl orthosilicate are also suitable first solvents and dissolve, or respectively solubilize novolac.

The first solvent is preferably polar with a dipole moment greater than 0 debye and preferably greater than 1 debye.

The first solvent, optionally containing a catalyst (see section 8) has a viscosity (Brookfield, 25° C.) of 0 to 50 mPas, preferably of 0.1 to 40 mPas, particularly preferably of 0.2 to 30 mPas, and especially preferably of 0.5 to 20 mPas at 25° C.

The first solvent, optionally containing a catalyst preferably also has a surface tension of 5 mN/m to 90 mN/m, preferably of 10 mN/m to 80 mN/m, particularly preferably of 15 mN/m to 75 mN/m and especially preferably of 20 mN/m to 70 mN/m, determined by the Wilhelmy plate method with a Krüss K100 force tensiometer at 20° C. To lower the surface tension, it is possible to additionally modify the solvent with surface-active substances.

The percentage of first solvent is preferably 20% by weight to 300% by weight, preferably 30% by weight to 150% by weight, and particularly preferably 40% by weight to 90% by weight relative to the novolac (without any carriers) independent of whether or not the mold base material is used.

To control the hardening speed, a second solvent (as described in section 7) can optionally be added to the first solution to slow the reaction, or a catalyst (section 8) can be added to accelerate the reaction.

(6) Isocyanate Component

The isocyanate component comprises at least one polyisocyanate. Suitable polyisocyanates are diisocyanates of an aromatic hydrocarbon with 6 to 15 carbon atoms like 2,6-phenylene diisocyanate, 2,4-phenylene diisocyanate, 2,2′-methylene diphenyl isocyanate, 2,4′-methylene diphenyl isocyanate, 4,4′-methylene diphenyl isocyanate, toluene-2,4-diisocyanate or toluene-2,6-diisocyanate, diisocyanates of an aliphatic hydrocarbon with 4 to 15 carbon atoms such as 1,6-hexamethylene diisocyanate, and/or diisocyanate of a cycloaliphatic hydrocarbon with 6 to 15 carbon atoms such as isophorone diisocyanate or 1,4-cyclohexyl diisocyanate.

Other suitable aliphatic polyisocyanates are for example hexamethylene diisocyanate, alicyclic polyisocyanates such as 4,4′-dicyclohexylmethane diisocyanate and dimethyl derivatives thereof. Examples of suitable aromatic polyisocyanates are toluene-2,4-diisocyanate (TDI), toluene-2,6-diisocyanate, 1,5-naphthalene diisocyanate, triphenylmethane triisocyanate, xylylene diisocyanate and methyl derivatives thereof, as well as polymethylene polyphenyl isocyanates such as diphenylmethane-2,2′-diisocyanate, diphenylmethane-2,4′-diisocyanate and/or diphenylmethane-4,4′-diisocyanate (these are termed MDI individually and as a mixture). The polyisocyanates can also be derivatized by reacting bivalent isocyanates with each other such that some of their isocyanate groups are derivatized to isocyanurate, biuret, allophanate, uretdione or carbodiimide groups. For example, uretdione groups that have dimerization products of for example diphenylmethane diisocyanates or toluene diisocyanates are suitable. Suitable modified isocyanates are uretonimine and/or carbodiimide modified 4,4′-diphenylmethane diisocyanates.

Typical commercial products are Lupranat MM 103, by BASF Polyurethanes (carbodiimide-modified 4,4′-di-phenylmethane diisocyanate) or Suprasec 2385 by Huntsman (uretonimine-modified MDI). These contain 10 to 35% by weight uretonimine and/or carbodiimide modified isocyanate compounds.

The isocyanate component that is used preferably has an average isocyanate group functionality per molecule greater than or equal to 2.

The isocyanate component can be used as a solid in a particulate, free-flowing form, as a liquid, or in solution.

The isocyanate component is preferably used in liquid form. If the isocyanate component itself is not present in a sufficiently low viscous form for it to be dosed to the molding material mixture, the isocyanate component must be dissolved in a suitable second solvent in order to convert the isocyanate component into a sufficiently low-viscous state. This is inter alia necessary in order to obtain even wetting and subsequent cross-linking of the refractory molding material, or to more easily dose the isocyanate component.

The added amount of the isocyanate component is normally 10 to 500% by weight, preferably 30 to 300% by weight, and particularly preferably 40 to 100% by weight relative to the novolac. If the novolac is supported, the support material is not considered in the calculation.

Relative to the construction material mixture when there is no construction base material in it, the isocyanate component is used at a concentration of 10 to 90% by weight, preferably of 20 to 80% by weight, and particularly preferably of 30 to 70% by weight.

(7) Second Solvent

The second solvent is solely optional. Suitable second solvents are organic, nonpolar solvents, or combinations of different nonpolar organic solvents that have the special property of not dissolving and also not solubilizing the novolac. Solubilizing means that the particulate novolac becomes tacky on the surface and cakes. This is undesirable.

Suitable solvents are aliphatic and cycloaliphatic hydrocarbons with 5-15 carbon atoms such as n-pentane and n-hexane, or aromatic hydrocarbons with 6-15 carbon atoms such as benzene, toluene, diisopropylnaphthalene, alkyl benzenes (such as Marlican® or Wibarcan®), or aromatic solvents known by the name of solvent naphtha. The added amount of the second solvent should be configured such that the viscosity of the isocyanate-component-containing solvent lies within a range of 0-400 mPas, and particularly preferably within a range of 0-150 mPas relative to 25° C. in each case. Many isocyanate types, such as uretonimine-modified MDI Suprasec 2385 by Huntsman, are already low viscous by nature such that an additional dilution with a second, nonpolar solvent is unnecessary.

For the method according to the invention, at least one first solvent that dissolves novolac, and possibly a second solvent that at least dissolves the polyisocyanate but not the novolac are used.

(8) Catalyst

Suitable catalysts are primarily tertiary amines, in particular those having a pK_{B} value of 3 to 11, in particular 4 to 11 at room temperature (25° C.) in a solid and liquid form that are soluble in the first solvent. Examples of suitable catalysts are trialkylamines like trimethylamine, triethylamine, hexamethylenetetramine or dimethylcylcohexylamine, heteroaromates comprising pyridines like pyridine itself, 4-aminopyridine, 2,4,6-trimethylpyridine, 2-ethanolpyridine, 4-phenylpropylpyridine, bipyridines like 2,2′-bipyridine or 4,4′-bipyridine, imidazoles like 1-ethylimidazole, 1-methylbenzimidazole or 1,2-dimethylimidazole. Catalysts such as 2-ethanolpyridine, 4-phenylpropylpyridine, 1-ethylimidazole or dimethylcylcohexylamine have proven to be particularly preferable.

The use of organometal catalysts such as inter alia dibutyltin dilaurate or metal octanoates of tin are cobalt, as well as metal oxides of for example iron or zinc.

The catalyst is preferably added together with the first solvent as the component to be printed, or also in the form of a free-flowing, particulate solid to the molding material mixture comprising the novolac and isocyanate component, and possibly molding material, or respectively in the form of a Croning sand together with the novolac supported on the mold base material within a range greater than 0% by weight to about 10% by weight, preferably of about 0.05% by weight to about 8% by weight, particularly preferably of about 0.1% by weight to about 5% by weight, and especially preferably of about 0.15% by weight to about 3% by weight relative to the novolac.

If no molding material is used, the catalyst is used within a range of greater than 0% by weight to about 10% by weight, preferably of about 0.05% by weight to about 8% by weight, particularly preferably of about 0.1% by weight to about 5% by weight, and especially preferably of about 0.15% by weight to about 3% by weight relative to the novolac (without any support).

It is also possible for alkaline regenerate sands with a pH greater than 7.5, preferably with a pH greater than 8 e.g. obtained using the cold box method, to possess a catalytic activity when they are added to the mold base material in amounts of 0.1% by weight to 100% by weight, preferably 0.5% by weight to 90% by weight, and particularly preferably of 1% by weight to 80% by weight.

(9) Additive

In addition to the aforementioned components, the construction material mixture can contain suitable additives. In this case, e.g. silanes (e.g. according to EP 1137500 B1) belong to the surface modification that are optionally added together with the isocyanate component or the first solvent into the molding material mixture, or respectively construction material mixture. Suitable silanes are for example amino silanes, epoxy silanes, mercapto silanes, hydroxy silanes and ureido silanes such as gamma-hydroxypropyl trimethoxysilane, gamma-aminopropyl trimethoxysilane, 3-ureidopropyl triethoxysilane, gamma-mercaptopropyl trimethoxysilane, gamma-glycidoxypropyl trimethoxysilane, beta-(3,4-epoxy-cyclohexyl)-trimethoxysilane and N-beta-(aminoethyl)-gamma-aminopropyl trimethoxysilane or other polysiloxanes. The added amounts of silanes lie between 0-5%, preferably between 0-2%, and particularly preferably between 0-1% relative to the novolac (without any support).

Moreover, organic or mineral additives such as iron oxides, silicates, aluminates, sawdusts or starches for preventing casting flaws can be added to the molding material mixture in an amount of 0-10%, preferably in amounts of 0-7%, and particularly preferably in amounts of 0-5%. Plastifiers such as fatty acids, silicones or phthalates to improve flexibility can also added in amounts of 0-8%, preferably 0-6%, and particularly preferably in amounts of 0-5% relative to the mold base material or the construction material mixture.

The invention will be explained below with reference to test examples without being restricted to them.

### EXAMPLES

Production of Molding Material Mixtures and Test Specimens

To test the molding material mixtures, square test bars were produced with the dimensions of 220 mm×22.36 mm×22.36 mm (so-called Georg Fisher bars).

The mold base material (D) was added to the bowl of a paddle vane type mixer by Beba. While stirring, first the novolac component (A) is subsequently added and then the isocyanate component (B), and each are mixed for one minute intensively with the mold base material. Then the first solvent (C) containing a catalyst is added to the molding material mixture which is stirred for another minute.

Part of the produced molding material mixtures was introduced into a molding tool with 8 engravings, compressed by being pressed with a handplate and removed from the molding tool after expiration of the demolding time.

Determining the Processing and Demolding Time

The processing time (PT), i.e. the time within which a molding material mixture can be easily compressed was determined visually. One can determine that the processing time has been exceeded when a molding material mixture stops flowing freely and rolls off in clods. To determine the demolding time (DT), i.e., the time after which a molding material mixture has hardened enough for it to be removed from the molding tool, a second part of the respective mixture was added manually to a round mold 100 mm high and 100 mm in diameter and also compressed with a handplate. Then the surface hardness of the compressed molding material mixture is tested at certain intervals in time by the Georg Fisher surface hardness tester. Once a molding material mixture is hard enough so that the test ball no longer penetrates into the core surface, the demolding time has been reached.

Determining Bending Strength

To determine the bending strength, the test bar was inserted into a Georg Fisher strength test apparatus equipped with a 3-point bending device, and the force was measured that caused the test bar to break. The bending strength was determined according to the following scheme:
1 hour after molding
2 hours after molding
4 hours after molding
24 hours after molding
24 hours after molding, plus 30 minutes heating at 120° C. after demolding

Test 1: Novolac and Isocyanate Component

The novolac component and isocyanate component were premixed with 100 parts by weight (PW) quartz sand H32, and then mixed with the first solvent containing a catalyst.

See Table 1 for the type and amounts of the individual components.

TABLE 1

| | Mold base | | | Solvent |
|---|---|---|---|---|
| | material | Novolac | Isocyanate | Catalyst |
| Mixture | [100 PW] | [PW] | [PW] | [PW] |
| 1 | H 32 ⁽ⁱ⁾ | 0.5^{(a)} | 0.8^{(d)} | 0.5^{(f)} |
| 2 | H 32 ⁽ⁱ⁾ | 0.7^{(a)} | 0.8^{(d)} | 0.5^{(f)} |
| 3 | H 32 ⁽ⁱ⁾ | 0.9^{(a)} | 0.8^{(d)} | 0.5^{(f)} |
| 4 | H 32 ⁽ⁱ⁾ | 0.7^{(a)} | 0.6^{(e)} | 0.5^{(f)} |
| 5 | H 32 ⁽ⁱ⁾ | 0.7^{(b)} | 0.6^{(e)} | 0.5^{(f)} |
| 6 | H 32 ⁽ⁱ⁾ | 0.7^{(c)} | 0.6^{(e)} | 0.5^{(f)} |
| 7 | H 32 ⁽ⁱ⁾ | 1.0^{(a)} | 1.0^{(d)} | 0.4^{(g)} |
| 8 | H 32 ⁽ⁱ⁾ | 1.0^{(a)} | 1.0^{(d)} | 0.4^{(h)} |

^{(a)}an unmodified novolac based on phenol and formaldehyde characterized by a flow length of 16-20 mm (PF 0235 DP, Hexion)
^{(b)}an unmodified novolac based on phenol and formaldehyde characterized by a flow length of 50-80 mm (Resin 2162, Chemiplastica)
^{(c)}an unmodified novolac based on phenol and formaldehyde characterized by a flow length of 40-60 mm (Resin 2173 F, Chemiplastica)
^{(d)}70% polymethylene polyphenyl isocyanate dissolved in solvent naphtha
^{(e)}uretonimine-modified polymethylene polyphenyl isocyanate (Suprasec 2385, Huntsman)
^{(f)}DBE (dibasic ester) containing 0.5% by weight 4-phenylpropylpyridine
^{(g)}DBE containing 2% by weight 4-phenylpropylpyridine
^{(h)}propylene carbonate containing 3% by weight 4-phenylpropylpyridine
⁽ⁱ⁾ quartz sand, Haltern Quarzwerke

The processing and demolding times as well as the bending strength of the individual mixtures are indicated in Table 2.

TABLE 2

| | |
|---|---|
| PT ^{(a)}/DT ^{(b)} | Bending strength [N/cm²] |

| | | | | | |
|---|---|---|---|---|---|
| Mixture | [Min.] | 1 h. | 2 h. | 4 h. | 24 h. |

| | | | | | | |
|---|---|---|---|---|---|---|
| 1 | 10 | 30 | 20 | 40 | 60 | 230 |
| 2 | 3 | 25 | 60 | 110 | 150 | 250 |
| 3 | 1 | 20 | 70 | 110 | 130 | 220 |
| 4 | 3 | 15 | 130 | 160 | 210 | 260 |
| 5 | 42 | 900 | n.d. | n.d. | n.d. | 260 |
| 6 | 45 | 960 | n.d. | n.d. | n.d. | 300 |
| 7 | 1 | 50 | 10 | 10 | 10 | 70 |
| 8 | 1 | 30 | 20 | 30 | 40 | 120 |

^{(a)} processing time
^{(b)} demolding time
n.d. = not determined

It was revealed that the processing and demolding times of the molding material mixtures can be specifically controlled by varying the type or added amount of the individual components.

Test 2: Mold Base Material and Post-Hardening

0.7 PW of the novolac component and 0.6 PW of the isocyanate component are added to 100 PW of a mold base material and mixed, and then mixed with 0.5 PW of the first solvent catalyst mixture.

See Table 3 for the type of the mold base material and the binder component.

TABLE 3

| | Mold base | | | Solvent |
|---|---|---|---|---|
| | material | Novolac ^{(a)} | Isocyanate ^{(b)} | catalyst ^{(c)} |
| Mixture | [100 PW] | [PW] | [PW] | [PW] |
| 1 | H 32 ^{(d)} | 0.7 | 0.6 | 0.5 |
| 3 | Spherichrome ^{(e)} | 0.7 | 0.6 | 0.5 |
| 4 | Cerabeads ^{(f)} | 0.7 | 0.6 | 0.5 |

^{(a)} a novolac based on phenol and formaldehyde characterized by a flow length of 16-20 mm (PF 0235 DP, Hexion)
^{(b)} Uretonimine-modified polymethylene polyphenyl isocyanate (Suprasec 2385, Huntsman)
g) DBE containing 0.5% by weight 4-phenylpropylpyridine
i) quartz sand, Haltern Quarzwerke
^{(e)} chromite sand (Oregon Resources Corporation in Europe, Possehl Erzkontor GmbH)
^{(f)} Cerabeads 650

The processing and demolding times as well as the bending strength of the individual mixtures are indicated in Table 4.

TABLE 4

| | | | Bending strength [N/cm²] | | | | |
|---|---|---|---|---|---|---|---|
| | | | | | | | 24 h ^{(c)} |
| | PT ^{(a)}/DT ^{(b)} | | | | | | 120° C./30 |
| Mixture | [Min.] | | 1 h. | 2 h. | 4 h. | 24 h. | min./cold |
| 1 | 2 | 9 | 160 | 180 | 200 | 300 | 420 |
| 2 | 12 | 85 | 30 | 60 | 180 | 760 | n.d. |
| 3 | 1 | 18 | 15 | 30 | 70 | 180 | n.d. |

^{(a)} processing time
^{(b)} demolding time
^{(c)} 24 h old cores/heated for 30 minutes at 120° C./strength measured after cooling
n.d. = not determined

The reactivity and strength can vary depending on the type of molding material. The strength level can be increased by up to 40% by subsequently rehardening in an oven.

Test 3: Life of the Molding Material Mixture Consisting of Mold Base Material (D), Component (A) and Component (B)

100 PW mold base material was premixed with 0.8 PW novolac component and 0.8 PW isocyanate component. To investigate the life of this premixture, a) the first solvent/catalyst mixture (mixture 1) was further mixed immediately, and b) 72 hours (mixture 2) after being produced.

See Table 5 for the type of the individual components.

TABLE 5

| | Mold base | | | Solvent ^{(c)} |
|---|---|---|---|---|
| | material | Novolac ^{(a)} | Isocyanate ^{(b)} | catalyst |
| Mixture | [100 PW] | [PW] | [PW] | [PW] |
| 1 | H 32 ^{(d)} | 0.8 | 0.8 | 0.5 |
| 2 | H 32 ^{(d)} | 0.8 | 0.8 | 0.5 |

^{(a)} an unmodified novolac based on phenol and formaldehyde characterized by a flow length of 16-20 mm (PF 0235 DP, Hexion)
^{(b)} Uretonimine-modified polymethylene polyphenyl isocyanate (Suprasec 2385, Huntsman)
g) DBE containing 1% by weight 4-phenylpropylpyridine
i) quartz sand, Haltern Quarzwerke

The processing and demolding times as well as the bending strength of the individual mixtures are indicated in Table 6.

TABLE 6

| | |
|---|---|
| PT ^{(a)}/DT ^{(b)} | Bending strength [N/cm²] |

| | | | | | |
|---|---|---|---|---|---|
| Mixture | [Min.] | 0.5 h. | 1 h. | 2 h. | 24 h. |

| | | | | | | |
|---|---|---|---|---|---|---|
| 1 | 1 | 10 | 80 | 90 | 120 | 160 |
| 2 | 1 | 20 | 50 | 70 | 100 | 140 |

^{(a)} processing time
^{(b)} demolding time

It was surprisingly determined that the final strength was only 12% less even after storing the molding material mixture consisting of component (A), (B) and the mold base material (D) for 72 hours.

Accordingly, the unbound molding material not printed with the first solvent can on the one hand be premixed and stored for a long period and, on the other hand, can be removed from the at least partially hardened molded body even after the printing process and supplied to produce another mold without fearing a significant loss of properties.

Test 4: Molding Tests

Molds that were produced using a novolac/isocyanate/first solvent molding material mixture revealed a comparable casting surface as standard cold box or PEP SET systems in the case of unfinished casting with iron at 1400° C.

Test 5: Hot Distortion Measurements (Hot Deformation)

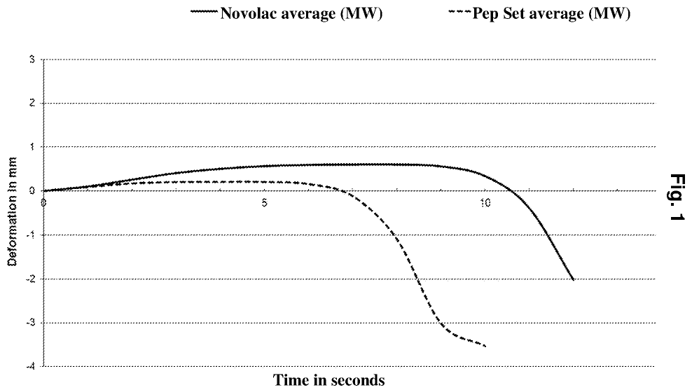

Cores that were produced using a novolac/isocyanate/first solvent molding material mixture revealed much better deformation properties than standard cold box or PEP SET systems. By the later drop of the deformation curve on the x-axis, FIG. 1 clearly reveals that a core consisting of mold base material that is bound with novolac/isocyanate/first solvent (solid curve) deforms much later when subject to heat (T=600° C.) than a core bound with PEP SET (dashed curve) based on the same mold base material. The deformation properties were investigated with a model 42114 hot distortion tester by Simpson. An average (MW) consisting of three individual measurements is shown.

1. A method for the layerwise construction of bodies comprising at least the following steps:
a) providing a construction material mixture comprising at least a novolac as a solid, and an isocyanate component comprising a polyisocyanate;
b) spreading a layer of the construction material mixture with a layer thickness of 0.05 mm to 3 mm;
c) printing selected regions of the layer with a first solvent, wherein the first solvent at least partially dissolves the novolac; and
d) multiple repetition of steps b) and c).

2. The method according to claim 1, wherein the construction material mixture further comprises a particulate mold base material.

3. The method according to claim 1, wherein the novolac is in the form of a free-flowing particulate solid with an average diameter between 0.1 μm and 700 μm.

4. The method according to claim 2, wherein the mold base material is at least partially encased with the novolac

5. The method according to claim 2, wherein the mold base material is encased with the novolac to form a component in the nature of a Croning sand in the presence of more than 0% by weight to 10% by weight hexamethylene tetramine relative to the novolac.

6. The method according to claim 1, wherein the isocyanate component is present in the form of a particulate solid, a liquid or a solution in a second solvent.

7. The method according to claim 1, wherein the polyisocyanate has an average isocyanate group functionality per molecule greater than or equal to 2.

8. The method according to claim 6, wherein the second solvent is an organic, nonpolar solvent, comprising aliphatic and/or cycloaliphatic hydrocarbons with 5 to 15 carbon atoms or aromatic hydrocarbons with 6 to 15 carbons and mixtures thereof.

9. The method according to claim 1, wherein the first solvent is an organic solvent, preferably an organic, aprotic solvent, comprising 1-25 carbon atoms.

10. The method of claim 1, wherein the first solvent is a polar solvent and has a dipole moment greater than 0.7 debye.

11. The method of claim 1, wherein the first solvent has a viscosity (Brookfield, 25° C.) of 0-50 mPa.

12. The method of claim 1, wherein the first solvent has a surface tension of 5 mN/m to 90 mN/m, at 20° C.

13. The method of claim 1, wherein the first solvent contains a catalyst, dissolved in the first solvent, for the urethane reaction.

14. The method of claim 1, further comprising a catalyst, dissolved in the first solvent, to provide a solution with a viscosity (Brookfield, 25° C.) of 0-50 mPa.

15. The method of claim 13, wherein the catalyst is a tertiary amine catalyst having a pK_{B} value of 3-11, is solid or liquid or dissolvable in a first solvent at an ambient temperature (25° C.), and the amine catalyst is in particular 4-phenylpropylpyridine, 2-ethanolpyridine, N-ethylimidazole, dimethylcylcohexylamine or hexamethylene tetramine or mixtures thereof.

16. The method of claim 1, wherein the catalyst is applied as a free-flowing, particulate solid in layers as part of the construction material mixture.

17. The method according to claim 2, wherein the mold base material has an average particle diameter of 30 μm to 700 μm.

18. The method of claim 1, wherein more than 80% by weight of the construction material mixture is mold base material.

19. The method of claim 15, wherein the novolac, isocyanate component, first solvent and tertiary amine are used, also independent of each other, as follows:
3 to 20% by weight novolac relative to the construction base material, or respectively, wherein no construction base material is used, 10% by weight to 90% by weight, novolac relative to the construction material mixture;
10 to 500% by weight of the isocyanate component relative to the novolac, or respectively, when no construction base material is used, 10% by weight to 90% by weight of the isocyanate component relative to the construction material mixture;
20 to 300% by weight of the first solvent relative to the novolac; and
0-10% by weight of the tertiary amine relative to the novolac.

20. The method of claim 1, comprising the further steps of:
i) after termination of layerwise construction, hardening the body in an oven or by microwaving, and then
ii) removing the unbound construction material mixture from the at least partially hardened mold.

21. The method of claim 1, wherein the printing is done with a print head having a plurality of nozzles, wherein the nozzles are preferably selectively controllable individually, wherein the print head is in particular a drop-on-demand print head with a bubble jet or piezo system.

22. The method according to claim 21, wherein the print head is movably controlled by a computer, at least in a plane, and the nozzles apply at least the first solvent in layers.

23. A mold or core producible according to the method of claim 1 for metal casting, in particular iron, steel, copper or aluminum casting.

24. A component system for producing a construction material mixture comprises the following components separately from each other:
Component (A) a novolac in the form of a free-flowing, particulate solid,
Component (B) an isocyanate component comprising at least one polyisocyanate with at least two isocyanate groups, the at least one polyisocyanate dissolved in a second solvent;
Component (C) a first solvent capable of dissolving a tertiary amine which further at least partially dissolves the free-flowing, particulate solid novolac,
wherein the first solvent is different from the second solvent, and the listed contents of the components are only contained in one of the components.

25. The component system according to claim 24, further comprising as another component separate from components (A) to (C):
Component (D) a free-flowing, particulate mold base material.

26. The component system according to claim 24, wherein the first solvent is an organic, aprotic solvent, comprising 1 to 25 carbon atoms, has bound oxygen in the form of one or more keto-, aldehyde- and/or ester groups, and in particular esters such as dimethyl glutarate, dimethyl succinate or dimethyl adipate, carbonic acid esters such as propylene, ethylene or dimethyl carbonate, gamma-butyrolactone, triacetin, tetraethylsilicate or mixtures thereof.

27. The component system of claim 24, wherein the first solvent is a polar solvent and has a dipole moment greater than 0.7 debye.

28. The component system of claim 24, wherein the first solvent has a viscosity (Brookfield, 25° C.) of 0 to 50 mPa.

29. The component system of claim 24, wherein the first solvent has a surface tension of 5 mN/m to 90 mN/m.

30. A free-flowing construction material mixture comprising:
a novolac in the form of a free-flowing, particulate solid,
an isocyanate component comprising at least one polyisocyanate with at least two isocyanate groups, and
a particulate mold base material,
wherein the novolac and the particulate mold base material forms a component in the nature of a Croning sand.

31. The construction material mixture according to claim 30, further comprising a first solvent, in which the novolac is at least partially soluble, and a second solvent that dissolves the polyisocyanate and is different from the first solvent.

32. The construction material mixture according to claim 31, wherein:
the second solvent is an organic, nonpolar solvent, comprising aliphatic and/or cycloaliphatic hydrocarbons with 5 to 15 carbon atoms or aromatic hydrocarbons with 6 to 15 carbons and mixtures thereof; and
the novolac has an average diameter between 0.1 μm and 700 μm.

33. The method according to claim 3, wherein the average diameter of the novolac is between 1 μm and 300 μm.

34. The method according to claim 2, wherein the mold base material is at least partially encased with the novolac, in the absence of hexamethylene tetramine

35. The method according to claim 9, wherein the first solvent has a bound oxygen in the form of one or more keto-, aldehyde- and/or ester groups, and in particular esters such as dimethyl glutarate, dimethyl succinate or dimethyl adipate, carbonic acid esters such as propylene, ethylene or dimethyl carbonate, gamma-butyrolactone, triacetin, tetraethylsilicate and mixtures thereof.
